(19) United States
(12) Patent Application Publication
(10) Pub. No.: US 2010/0090893 A1
(43) Pub. Date: Apr. 15, 2010

(54) User based positioning aiding network by mobile GPS station/receiver

(76) Inventor: Takayuki Hoshizaki, Torrance, CA (US)

Correspondence Address: MURAMATSU & ASSOCIATES, Suite 310, 114 Pacifica, Irvine, CA, 92618, US

(21) Appl. No.: 12/287,420

(22) Filed: Oct. 9, 2008

(51) Int. Cl. G01S 5/14

(52) U.S. Cl. 342/357.09

(57) ABSTRACT

A navigation system with a capability of receiving positioning aiding signals from other users is disclosed. The first aspect is to serve both roles of mobile GPS receiver and mobile GPS station by receiving signals from positioning reference sources and transmitting out the estimated position. The second aspect is to receive other users' position estimates information and to measure distances from other users in the positioning aiding purpose. According to the aspects noted above: (1) the users will have much better chances in finding positioning aiding signals than conventional differential GPS receivers; (2) the more users exist, the better positioning accuracy is obtained; (3) without building local stations, ubiquitous positioning aiding signals are available.

### FIELD OF THE INVENTION

This invention relates to a method and apparatus involving a vehicle and human navigation system, and more particularly, to a system architecture to achieve ubiquitous positioning aiding signals which are emitted by other users of navigation systems or other mobile devices. This networking is possible since each user serves both roles of a mobile GPS receiver and a mobile reference station simultaneously by exchanging position information and measuring the distance between the two users using Wi-Fi or Ultra Wideband (UWB) signals. Hereafter, this device will be referred to as “Network GPS Receiver” for convenience of describing the present invention.

### BACKGROUND OF THE INVENTION

After the development of global positioning system (GPS) made accurate positioning possible at low cost, accuracy enhancement technologies for GPS have been sought with great enthusiasm. Some of such technologies are briefly described in the following:

### Station Based Augmentation Systems

Conventional major GPS positioning aiding systems are based on “station based approach” in which local stations or geo-synchronous satellites send correction signals to end users. This technology is so called Differential GPS which has been developed since 1990s.

(a) Local Area Differential GPS (LADGPS): GPS accuracy depends on pseudorange (distance between a receiver and a satellite+clock bias) measurement. LADGPS utilizes a stationery station's known position to measure a local pseudorange error for each satellite. Measured pseudorange errors are transmitted to users in the proximity as range calibration allowing the higher accuracy the closer a user is located to the station. LADGPS provides accuracy about 2-5 m within the range up to 100 km under good clearance condition.

(b) Pseudolite: Additional LADGPS technique called pseudolite uses stationary ground stations as additional range sources just like satellites. Pseudolite gives significant improvement in geometry and accuracy. The applications can be found in aircraft precision landing around an airport as well as multipath mitigation in urban areas.

(c) Wide Area Differential GPS (WADGPS): WADGPS expands the capability of LADGPS to the range of one continent according to the following process: (1) Continent-widely distributed local stations transmit local calibration information to the master station; (2) Based on the gathered local information, the master station computes continent-wide calibration information and launches the information to a geo-stationary satellite; (3) Finally, the geo-stationary satellite transponders back the calibration information to users on the ground.

(d) Ranging Augmentation for Indoor Navigation: Recent interests in indoor navigation have encouraged development of ranging technologies using Wi-Fi signal based on IEEE 802.11 standards or Ultra-wideband (UWB) signals.

These station based approaches work fine as long as there is good clearance between stations and users, e.g., airborne precision landing applications around an airport. In case of automotive and pedestrian navigation applications, however, because of buildings and walls, differential signals are still susceptible to multipath and blockage as well as signals from GPS satellites. Also notice that cost to build a differential GPS station is significant in these station based approaches.

### Network Communication

In the meantime, recent development so-called “vehicle to vehicle communication” or “car to car communication” exchanges each platform's position information in the proximity. In this system, however, the position accuracy of each platform does not change from a single differential GPS. Topics of vehicle to vehicle communication are actively pursued globally these days. To fully utilize the potential of network transportation society, seamless and higher accuracy will be indispensable.

### Needs in Network Communication Transportation Society

Therefore, there is a need of a new positioning architecture to be supported by ubiquitous positioning aiding sources always available for seamless accuracy.

### SUMMARY OF THE INVENTION

It is, therefore, an object of the present invention to provide a positioning method and apparatus to have much better chances in finding positioning aiding sources in addition to the conventional GPS satellites.

It is another object of the present invention to provide a positioning method and apparatus for improving the positioning accuracy by using positioning aiding sources from other users in a seamless fashion.

It is a further object of the present invention to provide a positioning method and apparatus for maintaining the positioning accuracy even when sufficient GPS signals are unavailable by using positioning aiding sources from other users nearby.

One aspect of the present invention is that the proposed navigation system has the simultaneous capabilities of receiving signals from other user (mobile reference station) to estimate the position of the motion platform (mobile receiver) and transmitting out the estimated position as a reference (mobile reference station) to other user (mobile receiver).

Another aspect of the present invention is a navigation system which is able to measure distances from other users as positioning aiding sources. Either of Wi-Fi or UWB signals can be used in this purpose.

According to the present invention; (1) users can mutually help each other to enhance the positioning accuracy; (2) the more users exist, the better accuracy is available; (3) direct satellite signals access may not be necessary as long as enough aiding signals are available from other users; (4) local positioning aiding networks may connect each other to build a large network.

As noted above, within the context of the specification, the device of the present invention will be referred to as “Network GPS Receiver”.

### BRIEF DESCRIPTION OF THE DRAWINGS

FIGS. 1A and 1B are schematic diagrams showing basic system structures where FIG. 1A depicts conventional GPS receivers and FIG. 1B depicts Network GPS Receivers of the present invention, and FIG. 1C is a schematic diagram showing an example of situation where the present invention can be advantageously applicable.

FIGS. 2A and 2B are schematic diagrams showing an input-output relationship of the Network GPS Receiver of the present invention where FIG. 2A is directed to a Network GPS Receiver with tightly coupled system architecture and FIG. 2B is directed to a Network GPS Receiver with loosely coupled system architecture.

FIG. 3 is a schematic diagram explaining the projection of the travel path, L(k), onto the N-E-D coordinates using pitch and yaw angles based on a measurement model.

FIGS. 4A and 4B are graphs showing simulation results associated with a situation where sufficient GPS signals are unavailable where FIG. 4A shows the true vehicle path and FIG. 4B shows the GPS position estimates associated with FIG. 4A.

FIG. 5 is a graph showing the path estimates made by the conventional Kalman-filtering GPS receiver for the situation similar to that of FIGS. 4A and 4B.

FIGS. 6A and 6B are graphs showing simulation results associated with the situation similar to that of FIGS. 4A-4B and 5 where FIG. 6A shows the geometry of two standalone position estimates of User 1 and User 2 made by the conventional Kalman-filtering GPS receiver and FIG. 6B shows the estimated and true positions of User 2.

FIG. 7 is a graph showing the effects of the present invention related to the situation similar to that of FIGS. 4A-4B, 5, 6A-6B where the path estimates of User 1 made by the Network GPS Receiver is aided by User 2.

FIG. 8 is a flow chart showing an example of basic operational process for the Network GPS receiver of the present invention to enhance positioning accuracy utilizing signals from other users.

FIG. 9 shows matrix of equation involved in the Network GPS receiver of the present invention.

### DESCRIPTION OF THE PREFERRED EMBODIMENTS

The present invention will be described in detail with reference to the accompanying drawings. It should be noted that although a ground vehicle is mainly used in the following description, the present invention is not limited to such an application but can be implemented to other types of vehicles such as vessels, commercial aircraft, etc.

### System Architecture

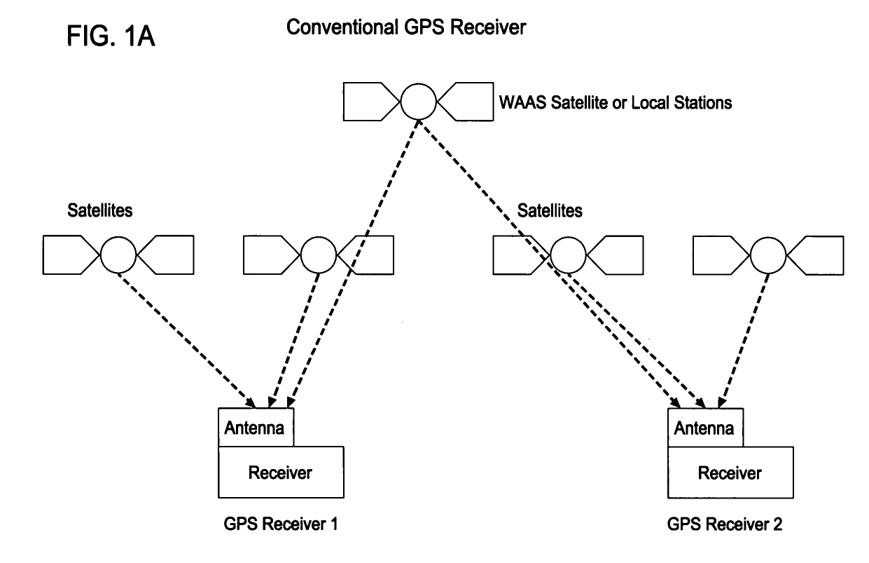

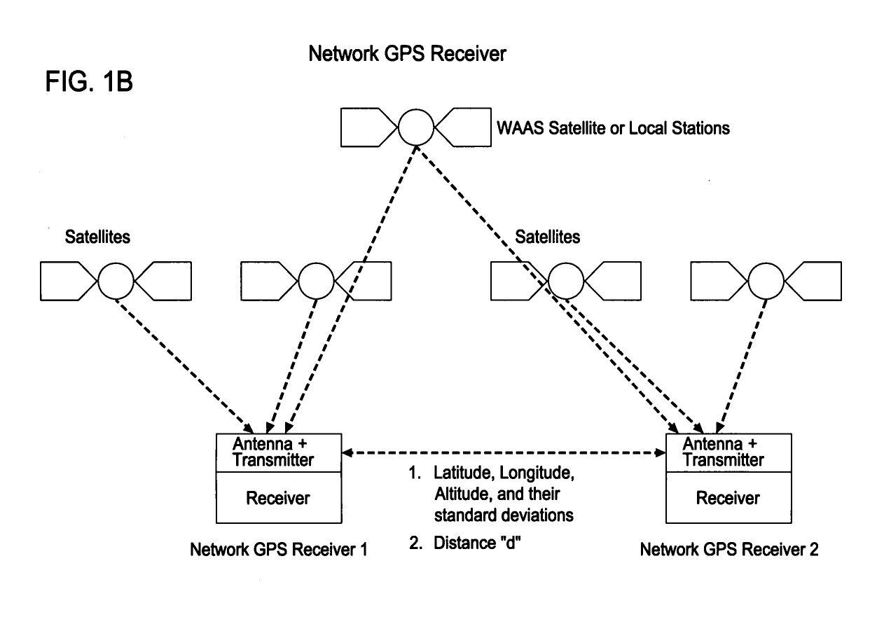

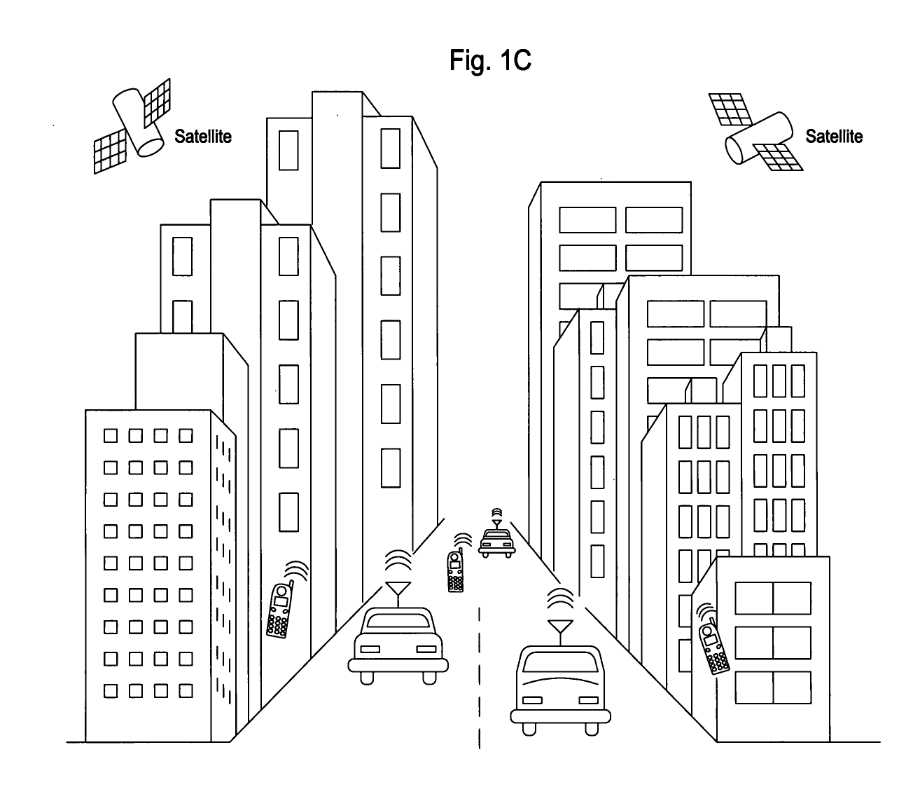

FIG. 1A is a schematic diagram showing the basic architecture of conventional GPS with differential signals coming from the WAAS (Wide Area Augmentation System) satellite or local stations. Notice that there is no communication between end users for positioning aiding purpose. FIG. 1B is a schematic diagram showing the basic architecture of Network GPS Receiver in which users form a network of positioning receiving aiding signals by each other. The suggested, but not limited, example aiding signals, such as from User 2, are:

φ₂: latitude

λ₂: longitude

h₂: altitude

σ_{φ2}: standard deviation (STD) of the latitude estimation in meters

σ_{λ2}: STD of the longitude estimation in meters

σₕ₂: STD of the altitude estimation in meters

d₁₂: distance between Users 2 and 1

In this architecture, each end user serves both roles of a mobile receiver and a mobile reference station at the same time.

Accordingly, as shown in a schematic diagram of FIG. 1C, even when GPS signals are insufficient or unavailable because of high-rise buildings, inside tunnel, etc., reasonably accurate positioning can be achieved by using the positioning aiding signals which are emitted by other users of Network GPS receivers. In the example of FIG. 1C, such Network GPS receivers are implemented in the form of vehicle navigation systems and cellular phones. Other example of electronic devices that include a Network GPS receiver therein may be a lap-top computer, palm computer, digital watch, etc.

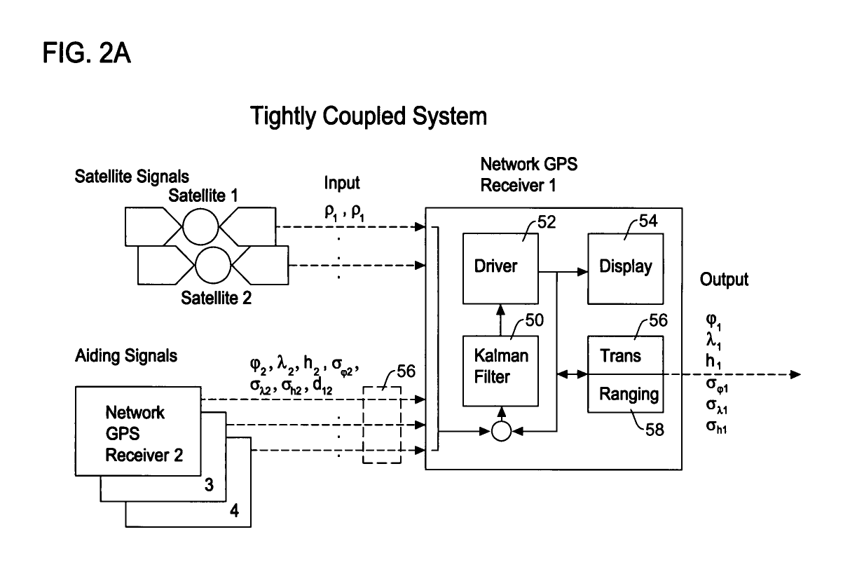

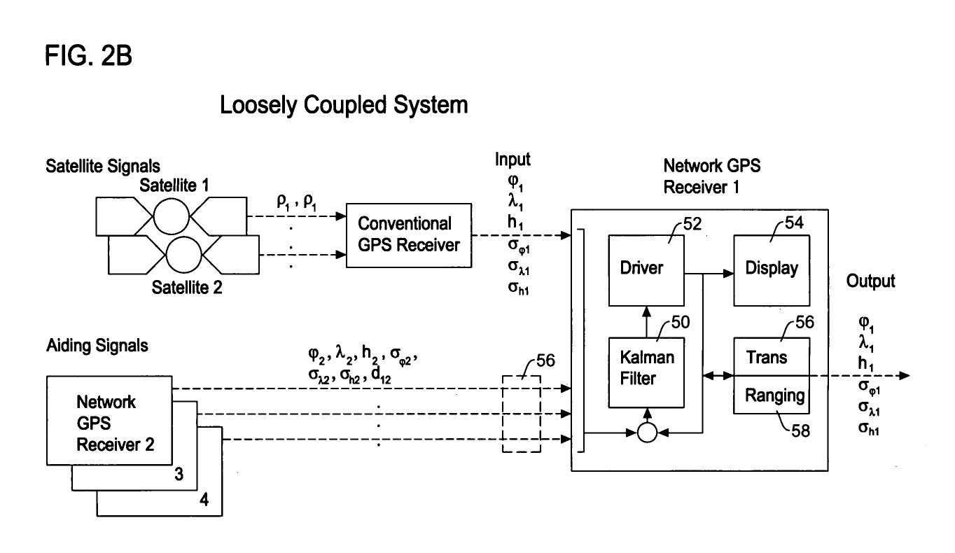

FIGS. 2A and 2B show the input-output relationship of Network GPS Receiver. FIG. 2A shows “tightly coupled system” which uses satellite signals (ρ: pseudoranges, ρ: pseudorange rates) and aiding signals from other Network GPS Receiver users (suppose aid from User n to User 1: (φₙ, λₙ, hₙ, σ_{λn}, σₕₙ, d₁ₙ) as input. For designers who have direct access to raw satellite signals, such as GPS receiver vendors, may prefer the tightly coupled system solution. FIG. 2B shows “loosely coupled system” which uses a conventional GPS receiver as the interface to satellite signals to obtain first positioning solution of φ₁, λ₁, h₁, σ_{φn}, σ_{λn}, and σₕ₁ available by the NMEA (National Marine Electronics Association) format. The Network GPS Receiver in this case uses the first positioning solution from a conventional GPS receiver and aiding signals from other Network GPS Receiver users (suppose aid from User n to User 1: φₙ, λₙ, hₙ, σ_{φn}, σ_{λn}, σₕₙ, d₁ₙ) as input. For designers who do not have direct access to raw satellite signals, such as automotive navigation system vendors, may prefer the loosely coupled system solution. The output signals of either system are, for User 1, the refined position estimates and their accuracy information: φ₁, λ₁, h₁, σ_{φ1}, σ_{λ1}, and σₕ₁.

In either the tightly coupled system or loosely coupled system, the Network GPS Receiver basically comprises a Kalman filter 50, a driver 52, a display 54, a transceiver (transmitter) 56, and a ranging device 58. In an actual application, the Kalman filter 50, the driver 52 and the ranging device 58 will be implemented by a computer such as a microprocessor. The Kalman filter 50 processes GPS signals from satellites (tightly coupled system) or positioning signals from the conventional GPS Receiver (loosely coupled system). The Kalman filter 50 also processes the positioning aiding signals from Network GPS Receivers of other users received via the transceiver 56. The output of the Kalman filter 50 is processed by the driver 52 to produce the position data which will be sent to the display 54. Thus, the display 54 will show the current position of the user of the Network GPS Receiver 1. The ranging device 58 measures a distance between the Network GPS Receiver 1 and other Network GPS Receivers based on the physical features of the signals between them, for example, a time elapsed during the travel, i.e., TOA (Time of Arrival), and a phase difference for precision application, and a signal strength for coarse application. The measured distance is used to estimate the positional relationship between two or more Network GPS Receivers under the present invention.

### Conventional Navigation Solution

Here, the conventional approach is reviewed since the Network GPS Receiver solution of the present invention is a modification of the conventional approach. The Kalman filtering technique is referred here which is used in almost every navigation device nowadays. Note that although detailed equations differ in every Kalman filtering system according to its dynamics modeling and measurements available, the framework is unique and known, which is briefly stated in the following:

1. Set up nonlinear dynamics and measurement model:

Xₖ₊₁=f(xₖ,uₖ) (1) state equation

Zₖ=hₖ(Xₖ)+Vₖ (2) measurement equation

where

x: estimation vector containing parameters we want to estimate, such as position coordinates, velocities, orientation and so on.

Xₖ: =x(tₖ), or, x at the k-th discretely-counting time

u: control input often available by dead reckoning sensors, such as accelerometers

f(xₖ, uₖ): non-linear dynamics governing the motion of x

z: measurement vector, such as pseudoranges

h: non-linear measurement equation vetor to describe measurements in terms of x

v: measurement error represented by white noise

When z comprises pseudoranges (distances between a receiver and satellites+clock bias), it is called a tightly coupled system while when z comprises position and velocity solutions given by internal GPS filter, it is called a loosely coupled system. This invention is applicable to either of the system (see FIGS. 2A and 2B).
2. Prepare linearized small perturbation equations:

δxₖ₊₁=Φ(\hat{x}ₖ)δXₖ+Γₖwₖ

δzₖ=H(\hat{x}ₖ)δXₖ+Vₖ

where

̂(hat) means an estimate, e.g., “\hat{x}” is an estimate of x

δx: =−\hat{x}, or estimation error vector

Γ: matrix to relate δx and noise w

w: input noise vector contained in the dynamics model represented by white noise

Φ(\hat{x}ₖ): transient matrix, or, partial derivative of f in terms of \hat{x}

H(\hat{x}ₖ): measurement matrix, or, partial derivative of h in terms of \hat{x}

v: measurement error represented by white noise

3. Propagate nonlinear state equations and the covariance:

\hat{x}ₖ₊₁⁻=f(\hat{x}ₖ,uₖ)

Pₖ₊₁⁻=ΦₖPₖ⁻Φₖ^{T}+ΓₖQₖΓₖ^{T}

where

P: covariance of \hat{x}

Q: covariance of w

### 4. Perform Local Iteration:

K_{k,i}=Pₖ⁻Hₖ^{T}(\hat{x}_{k,i}⁺)(Hₖ(\hat{x}_{k,i}⁺)Pₖ⁻Hₖ^{T}(\hat{x}_{k,i}⁺)+Rₖ)⁻¹

\hat{x}_{k,i+1}⁺=\hat{x}ₖ⁻+K_{k,i}[zₖ−hₖ(\hat{x}_{k,i}⁺)−Hₖ(\hat{x}_{k,i}⁺)(\hat{x}ₖ⁻−\hat{x}_{k,i}⁺)]

P_{k,i+1}⁺=(I−K_{k,i}Hₖ(\hat{x}_{x,i}⁺))Pₖ⁻

where

K: Kalman filter gain

R: covariance of v

5. Sequentially repeat the steps 3 and 4:
This ends the process.

### Network GPS Receiver Solution

This invention does not change the general Kalman filtering procedure, but only augments the measurement vector with measured distances from Network GPS Receivers of other users. Suppose that while User 1 is tracking the trajectory, User 2 is available as an aiding source for User 1. Although reference does not need to be only one, this explanation uses one reference as an illustration purpose:

N1. User 2 transmits position information:

φ₂: latitude

λ₂: longitude

h₂: altitude

σ_{φ2}: STD of the latitude estimation in meters

σ_{λ2}: STD of the longitude estimation in meters

σₕ₂: STD of the altitude estimation in meters

N2. User 1 measures distance from User 1:

Upon arrival of data messages from User 2, User 1 measures the distance between User 2 and User 1 based on the physical features of the signals between them, for example, a time elapsed during the travel, i.e., TOA (Time of Arrival), and a phase difference for precision application, and a signal strength for coarse application.

d₁₂: measured distance between User 2 and User 1

(There is so-called 2-way technique to measure ranges in which the transmitter side measures the distance by transpondered signal. The use of 2-way method will change the procedure which is considered trivial.)
N3. User 1 augments the KF (Kalman filtering) procedure with aiding measurements:

User 1 uses the measured distance as another measurement to compute the Kalman filter updates according to the following scheme:

A3.1 Augment zₖ with the measured distance, d₁₂

A3.2 Augment hₖ (\hat{x}ₖ) with the estimated distance, d_{KF} (\hat{x}ₖ)

$$A 3.3 Augment H ( {\hat{x}}_{k} ) with \frac{\partial {d}_{KF} ( {x}_{k} )}{\partial {x}_{k}} {\vert}_{{\hat{x}}_{k}}$$

A3.4 Adjust the size of [symbol] R according to reported σ_{φ2}, υ_{λ2}, and σₕ₂

N4. Perform conventional KF:
Perform the same algorithm as the conventional scheme with the new measurement. This ends the process.

### EXAMPLE

To verify mathematical implementation clearly, and to visualize the effect of powerful Network GPS Receiver of the present invention, an illustrative example of KF modeling is provided in this subsection.

Suppose that User 1 drives through a place of GPS dropouts (i.e., GPS signals are temporarily unavailable) where User 2 is staying nearby. Here, comparison will be made between the conventional standalone solution and the network solution in studying actual equations:

1. Set up nonlinear dynamics and measurement model:

xₖ₊₁=f(xₖ,Uₖ) (1) state equation

where

Xₖ=[Nₖ Eₖ Dₖ Sₖ \dot{S}ₖ θₖ ψₖ \dot{ψ}ₖ]^{T}

N: northerly displacement

E: easterly displacement

D: downward displacement

S: speed of the vehicle along the vehicle fixed coordinate system

\dot{S}: acceleration of the vehicle along the vehicle fixed coordinate system

θ: pitch angle of the vehicle

ψ: yaw (azimuth) angle of the vehicle

\dot{ψ}: yaw rate of the vehicle

Xₖ₊₁=f(Xₖ) is given by the following using the time step between GPS signals, ΔT:

$$\begin{matrix}[ \begin{matrix}N ( k + 1 ) \\ E ( k + 1 ) \\ D ( k + 1 )\end{matrix} ] = [ \begin{matrix}N ( k ) \\ E ( k ) \\ D ( k )\end{matrix} ] + ( S ( k ) Δ T + \frac{1}{2} \dot{S} ( k ) Δ {T}^{2} ) [ \begin{matrix}cos {θ}_{k} cos {ψ}_{k} \\ cos {θ}_{k} sin {ψ}_{k} \\ - sin {θ}_{k}\end{matrix} ] & ( 1.1 ) \\ S ( k + 1 ) = S ( k ) + \dot{S} ( k ) Δ T + {w}_{s} ; where {σ}_{S} = 2 m / s is the STD of {w}_{s} & ( 1.2 ) \\ \dot{S} ( k + 1 ) = \dot{S} ( k ) + {w}_{\dot{S}} ; where {σ}_{\dot{S}} = 1 m / {s}^{2} is the STD of {w}_{\dot{S}} & ( 1.3 ) \\ θ ( k + 1 ) = θ ( k ) + {w}_{θ} ; where {σ}_{θ} = 1 deg is the STD of {w}_{θ} & ( 1.4 ) \\ ψ ( k + 1 ) = ψ ( k ) + \dot{ψ} ( k ) Δ T + {w}_{ψ} ; where {σ}_{ψ} = 10 deg is the STD of {w}_{ψ} & ( 1.5 ) \\ \dot{ψ} ( k + 1 ) = {w}_{\dot{ψ}} ; where {σ}_{\dot{ψ}} = 1 deg / s is the STD of {w}_{\dot{ψ}} & ( 1.6 )\end{matrix}$$

Note that the first vector equation represents that the travel distance of

$$L ( k ) = S ( k ) Δ T + \frac{1}{2} \dot{S} ( k ) Δ {T}^{2}$$

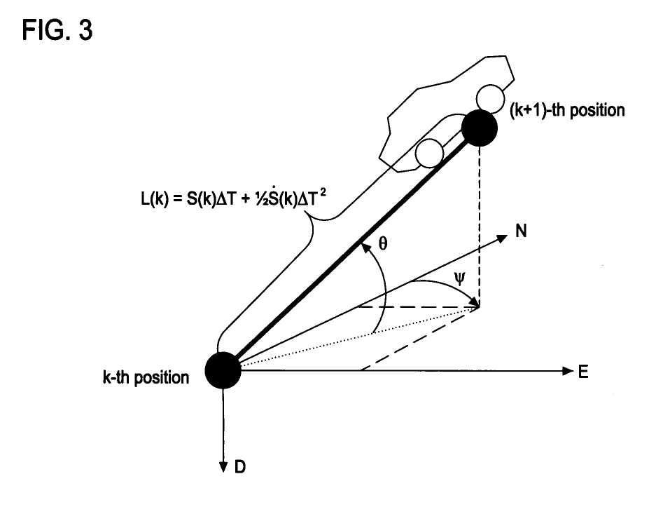

is projected onto North, East, and Sown directions as depicted in FIG. 3.

Also, assuming that a GPS receiver produces estimates of latitude φ_{GPS}, longitude λ_{GPS}, altitude h_{GPS}, and their accuracy information σ_{φGPS}, σ_{λGPS} and σ_{hGPS} to build a loosely coupled system schematically shown in FIG. 2B. In this configuration, the system obtains the following measurement equation for the conventional approach:

Zₖ=hₖ(Xₖ)+Vₖ (2) measurement equation, or

$$[ \begin{matrix}{N}_{GPS} ( k ) \\ {E}_{GPS} ( k ) \\ {D}_{GPS} ( k )\end{matrix} ] = [ \begin{matrix}N ( k ) \\ E ( k ) \\ D ( k )\end{matrix} ] + [ \begin{matrix}{v}_{ϕ GPS} \\ {v}_{λ GPS} \\ {v}_{hGPS}\end{matrix} ] \qquad ( 2.1 ) measurement for conventional system$$

where V_{φGPS}, v_{λGPS}, and v_{hGPS} are measurement errors modeled by white noises whose STDs are σ_{φGPS}, σ_{λGPS}, and σ_{hGPS}. Note that N_{GPS}, E_{GPS}, and D_{GPS} are computed by

N_{GPS}≅R_{N}(φ_{GPS}−φ₀)

E_{GPS}≅R_{E}(λ_{GPS}−λ₀) COS (φ_{GPS})

D_{GPS}=−h_{GPS}

where R_{N} is a meridian (North-South) radius of curvature and R_{E} is an East-West radius of curvature.
N1. User 2 transmits position information:

User 2 is sending out the position estimates and accuracy information: φ₂, λ₂, h, σ_{φ2}, σ_{λ2}, and σₕ₂:

N2. User 1 measures distance from User 1:

Suppose d₁₂ is a measured distance in meters.

N3. User 1 augments the KF procedure with aiding measurements:

User 1 computes the value d_{KF} corresponding to measured d₁₂.

$$\begin{matrix}{d}_{12} = \sqrt{{( {N}_{2} - N )}^{2} + {( {E}_{2} - E )}^{2} + {( {D}_{2} - E )}^{2}} + \\ {v}_{d 12} \\ = {d}_{KF} + {v}_{d 12}\end{matrix} \\ where {d}_{KF} = \sqrt{{( {N}_{2} - N )}^{2} + {( {E}_{2} - E )}^{2} + {( {D}_{2} - E )}^{2}} \qquad ( 2.2 ) network aiding$$

Again, N₂, E₂, and D₂ used in the distance measurement are computed by

N₂R_{N}(φ₂−φ₀)E₂≅R_{E}(λ₂−λ₀) COS(φ₂)

The STD of v_{d12} depends on the ranging method to measure the distance and the accuracy of user 2 position estimates.
2. Prepare linearized small perturbation equations:

$$δ {x}_{k + 1} = Φ ( {\hat{x}}_{k} ) δ {x}_{k} + {Γ}_{k} {w}_{k} , or$$

$$\begin{matrix}[ \begin{matrix}δ {N}_{k + 1} \\ δ {E}_{k + 1} \\ δ {D}_{k + 1}\end{matrix} ] = [ \begin{matrix}δ {N}_{k} \\ δ {E}_{k} \\ δ {D}_{k}\end{matrix} ] + [ \begin{matrix}cos {\hat{θ}}_{k} cos {\hat{ψ}}_{k} \\ cos {\hat{θ}}_{k} sin {\hat{ψ}}_{k} \\ - sin {\hat{θ}}_{k}\end{matrix} ] Δ T δ S + [ \begin{matrix}cos {\hat{θ}}_{k} cos {\hat{ψ}}_{k} \\ cos {\hat{θ}}_{k} sin {\hat{ψ}}_{k} \\ - sin {\hat{θ}}_{k}\end{matrix} ] \frac{1}{2} Δ {T}^{2} δ \dot{S} + [ \begin{matrix}- sin {\hat{θ}}_{k} cos {\hat{ψ}}_{k} \\ - sin {\hat{θ}}_{k} sin {\hat{ψ}}_{k} \\ - cos {\hat{θ}}_{k}\end{matrix} ] {\hat{L}}_{k} δθ + [ \begin{matrix}- cos {\hat{θ}}_{k} sin {\hat{ψ}}_{k} \\ cos {\hat{θ}}_{k} cos {\hat{ψ}}_{k} \\ 0\end{matrix} ] {\hat{L}}_{k} δθ & ( 1.1 ) \\ δ S ( K + 1 ) = δ S ( k ) + δ \dot{S} ( k ) Δ T & ( {1.2}^{′} ) \\ δ \dot{S} ( k + 1 ) = δ \dot{S} ( k ) + {w}_{\dot{S}} & ( {1.3}^{′} ) \\ δθ ( k + 1 ) = δθ ( k ) + {w}_{θ} & ( {1.4}^{′} ) \\ δψ ( k + 1 ) = δψ ( k ) + \dot{ψ} ( k ) Δ T & ( {1.5}^{′} ) \\ δ \dot{ψ} ( k + 1 ) = {w}_{\dot{ψ}} \\ δ {z}_{k} = z - h ( {\hat{x}}_{k} ) = H ( {\hat{x}}_{k} ) δ {x}_{k} + {v}_{k} , or \\ [ \begin{matrix}δ {N}_{GPS} ( k ) \\ δ {E}_{GPS} ( k ) \\ δ {D}_{GPS} ( k )\end{matrix} ] = [ \begin{matrix}δ N ( k ) \\ δ E ( k ) \\ δ D ( k )\end{matrix} ] + [ \begin{matrix}{v}_{ϕ GPS} \\ {v}_{λ GPS} \\ {v}_{hGPS}\end{matrix} ] \\ δ {d}_{12} = - \frac{{N}_{2} - N}{{d}_{KF}} δ N - \frac{{E}_{2} - E}{{d}_{KF}} δ E - \frac{{D}_{2} - D}{{d}_{KF}} δ D + {v}_{d 12} & ( {1.6}^{′} )\end{matrix}$$

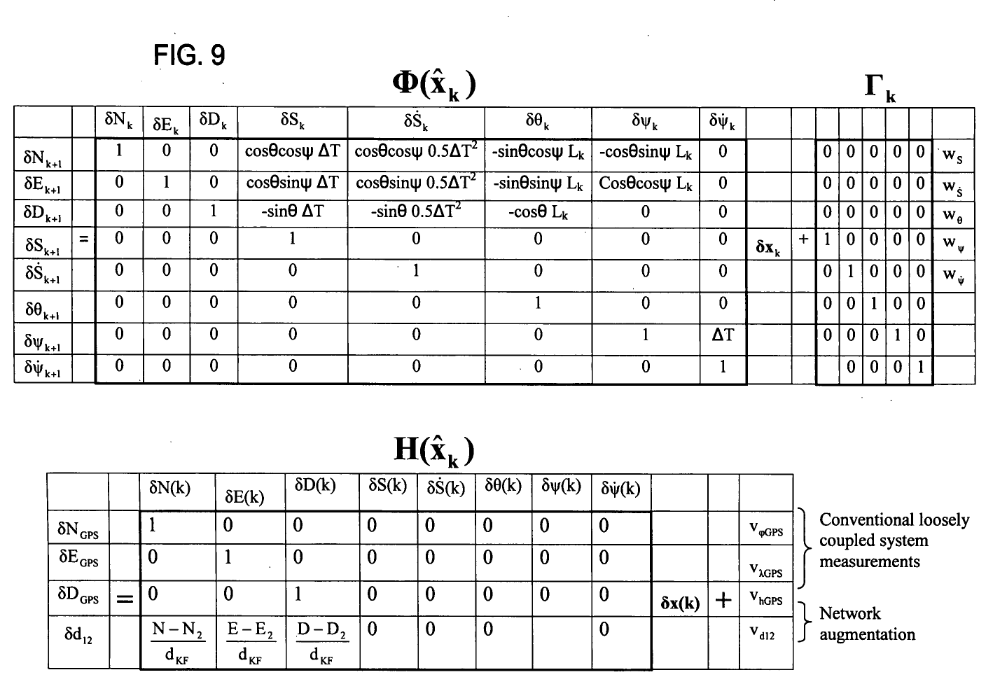

These equations can be represented by matrix format as shown in FIG. 9. Note that the additional augmentation using the aiding signals from other Network GPS receiver is illustrated at the bottom of FIG. 9.
3. Propagate nonlinear state equations and the covariance:
4. Perform local iteration:
5. Sequentially repeat the steps 3 and 4:
The rest of the procedure is to sequentially repeat the aforementioned steps 3 and 4 with

$${Q}_{k} = E [ {w}_{k} {w}_{k}^{T} ] = [ \begin{matrix}{σ}_{S}^{2} & 0 & 0 & 0 & 0 \\ 0 & {σ}_{S}^{2} & 0 & 0 & 0 \\ 0 & 0 & {σ}_{θ}^{2} & 0 & 0 \\ 0 & 0 & 0 & {σ}_{ψ}^{2} & 0 \\ 0 & 0 & 0 & 0 & {σ}_{ψ}^{2}\end{matrix} ]$$

$${R}_{k} = E [ {v}_{k} {v}_{k}^{T} ] = [ \begin{matrix}{σ}_{ϕ GPS}^{2} & 0 & 0 & 0 \\ 0 & {σ}_{λ GPS}^{2} & 0 & 0 \\ 0 & 0 & {σ}_{hGPS}^{2} & 0 \\ 0 & 0 & 0 & {σ}_{d 12}^{2}\end{matrix} ]$$

where σ_{φGPS}, σ_{λGPS}, and σ_{hGPS} are given by a GPS receiver; σ_{d12} is a function of σ_{φ2}, σ_{λ2}, σₕ₂, and performance of the ranging device.

### Simulation Results

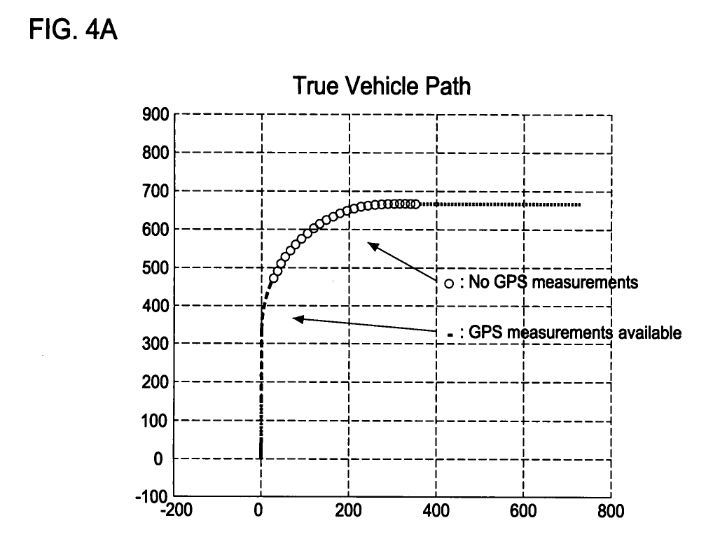

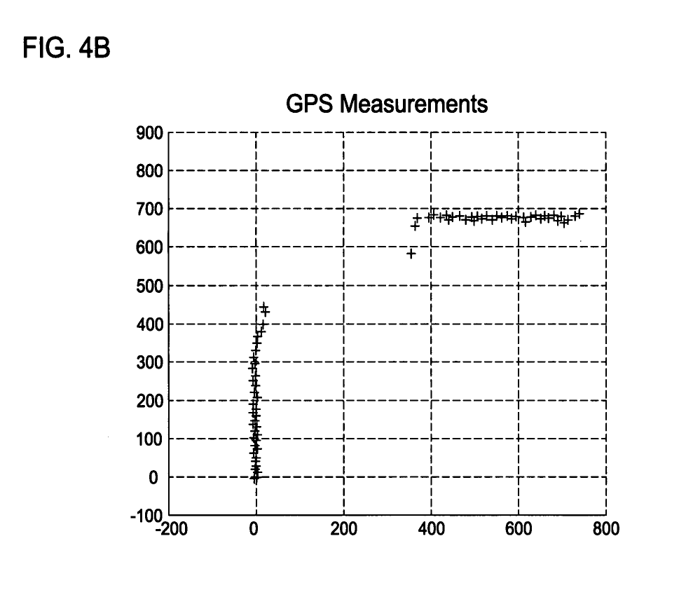

FIG. 4A represents the true vehicle path where “•(dots)” represent the path with GPS measurements available, and “∘(circles)” for the path where GPS measurements are lost because of a tunnel, high rise buildings, under a bridge, on a big 3D ramp to access a freeway with another ramp overhead, in a parking structure, or any reason. FIG. 4B represents GPS estimates of the true path with “+(plus)” which are the true path with additive white noise in this simulation. When GPS are available, measurement is made with either of σ_{φGPS}, σ_{λGPS}, and σ_{hGPS} are 10 m or less, however, there is a period of GPS dropout for 20 seconds during the cornering thereby disabling to correctly estimate the vehicle position. This is a very realistic situation that happens often in an urban area.

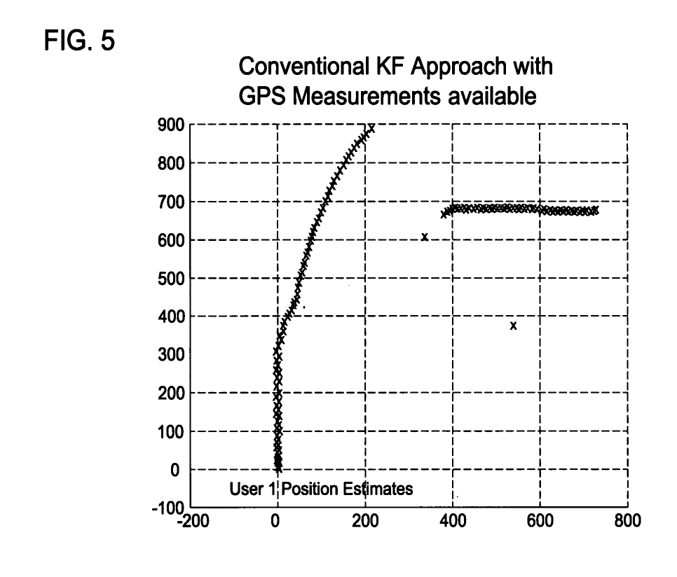

With these primary GPS measurements, the conventional Kalman filter implementation without the network aiding of the present invention will result in as shown in FIG. 5. Notice that the interpolation made by KF dynamics modeling diverges from the path shown in FIG. 4A while GPS dropouts. Using the same measurement data, elaborating the dynamics model without extra sensor measurements will result in vain.

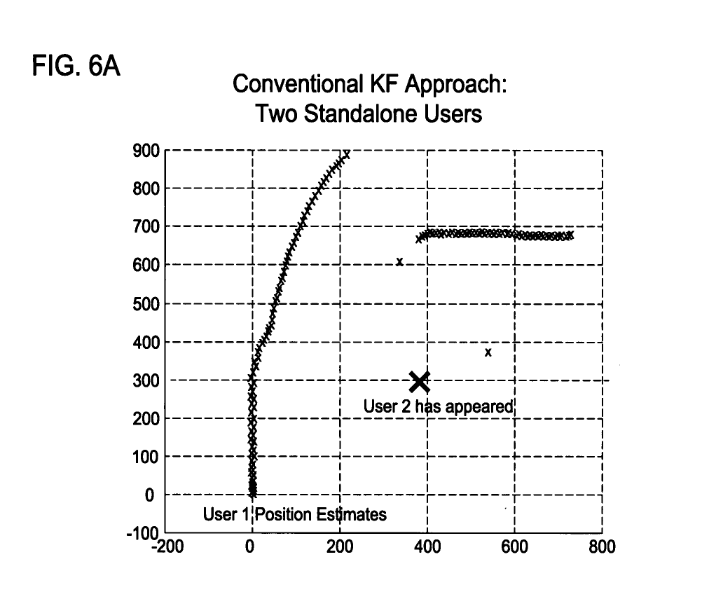

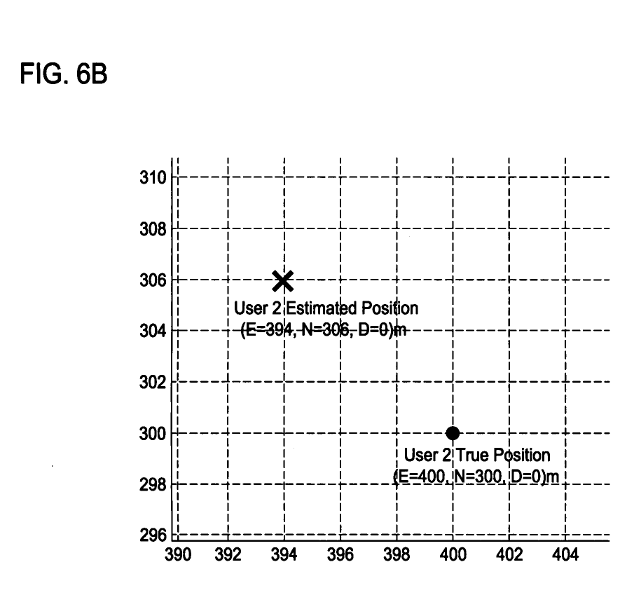

Now suppose that User 2 has appeared as depicted by “x (crossing)” in FIG. 6A. In the example of FIG. 6A, however, since only the conventional KF approach is taken, it shows basically the same result as that of FIG. 5. It is assumed that User 2 true N-E-D coordinates are (400, 300, 0) m but assume that its estimated position contains horizontal offset to have (394, 306, 0) m as shown in FIG. 6B.

User 2 transmits the position estimates and accuracy information to User 1

φ₂=value corresponding to N₂=306 m

λ₂=value corresponding to E₂=394 m

h₂=0

σ_{φ2}=σ_{λ2}=σₕ₂=10 m

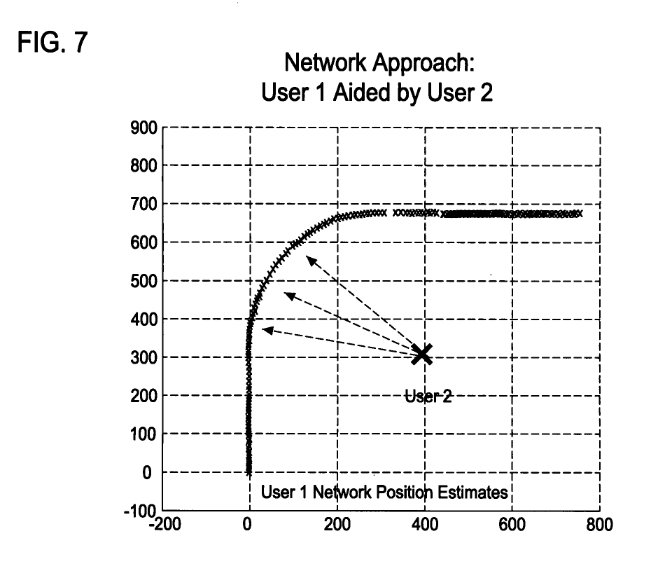

In this simulation, the ranging device 58 (FIGS. 2A and 2B) has additive white noise of STD of 1 m to the true distance measurement. Based on the reported position accuracy information of σ_{φ2}=σ_{λ2}=σₕ₂=10 m, however, σ_{d12}=10 m is decided. The Network GPS Receiver solution is shown in FIG. 7 in which User 1 path estimates are much smoother compared with FIG. 5 or 6A. This smooth path is obtained even though User 2 position reference is not of very accurate as conventional reference stations because User 2 is much closer to User 1 than the conventional reference stations resulting in much better geometry. Note that, although the aiding direction is from User 2 to User 1 in this example, User 2 will have simultaneous benefits from User 1 as well in the actual situation.

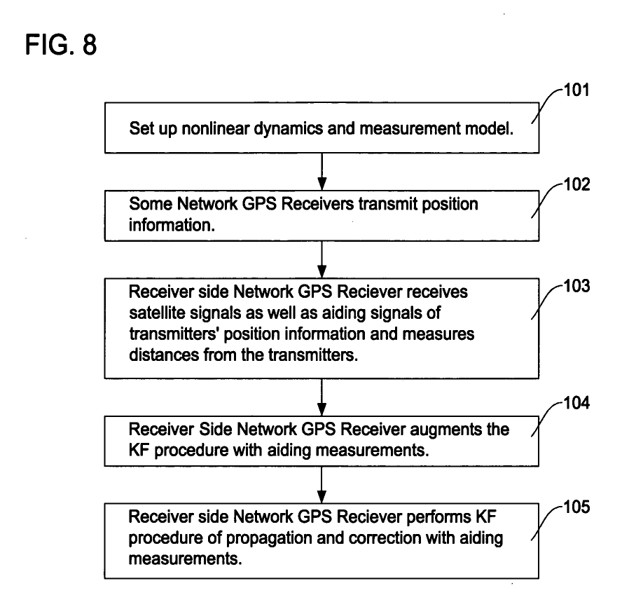

The flowchart of FIG. 8 summarizes an overall operation of the Network GPS Receiver solution under the present invention. In the step 101, the process first establishes the nonlinear dynamics and measurement model described above with reference to FIG. 3. In the step 102, some Network GPS Receivers which may be implemented in the form of vehicle navigation system, cellular phone, etc. exchange position information (aiding signals) via wireless transmission devices such as a transceiver 56 in FIGS. 2A and 2B. In the step 103, the Network GPS Receiver in the receiver side receives the GPS satellite signals as well as signals from the Network GPS Receiver in the transmitter side indicating its position estimates with accuracy information and measures the distance between them based on the physical features of the signals between them, for example, a time elapsed during the travel, i.e., TOA (Time of Arrival), and a phase difference for precision application, and a signal strength for coarse application. Then, the receiver side Network GPS Receiver augments the KF procedure with aiding measurement in the step 104. Finally, in the step 105, the receiver side Network GPS Receiver performs the KF procedure of propagation and correction with the aiding measurement.

Although the invention is described herein with reference to the preferred embodiment, one skilled in the art will readily appreciate that various modifications and variations may be made without departing from the spirit and scope of the present invention. Such modifications and variations are considered to be within the purview and scope of the appended claims and their equivalents.

What is claimed is:

1. A method of computing a platform position of a network receiver, comprising the following steps of:
receiving GPS signals from satellites and processing the GPS signals for producing position estimation information;
receiving position information from other user's network receiver and measuring a distance from the other user's network receiver; and
incorporating the distance produced from the position information from the other user's network receiver into the position estimation information produced from the GPS signals, thereby correcting the platform position.

2. A method of computing a platform position of a network receiver, comprising the following steps of:
receiving GPS signals from satellites by a GPS receiver where the GPS receiver processes the GPS signals for producing its position estimation information;
sending the position estimation information of the GPS receiver to the network receiver;
receiving position information from other user's network receiver and measuring a distance from the other user's network receiver; and
incorporating the distance produced from the position information from the other user's network receiver into the position estimation information produced by the GPS receiver, thereby correcting the platform position.

3. A navigation system for computing a platform position of a network receiver, comprising:
a transceiver for wirelessly sending and receiving position information with other user's network receiver;
a ranging device for measuring a distance between the network receiver and the other user's network receiver based on the position information received by the transceiver; and
a Kalman filter for receiving GPS signals from satellites to produce position estimation information;
wherein said Kalman filter conducts a Kalman filtering procedure on the position estimation information derived from the GPS signals and the distance measured by the ranging device, thereby correcting the platform position.

4. A navigation system for computing a platform position of a network receiver, comprising:
a GPS receiver for receiving GPS signals from satellites and processing the GPS signals for producing position estimation information;
a transceiver for wirelessly sending and receiving position information with other user's network receiver;
a ranging device for measuring a distance between the network receiver and the other user's network receiver based on the position information received by the transceiver; and
a Kalman filter for conducting a Kalman filtering procedure on the position estimation information from the GPS receiver and the distance measured by the ranging device, thereby correcting the platform position.
